(19) United States
(12) Patent Application Publication
(10) Pub. No.: US 2008/0079399 A1
(43) Pub. Date: Apr. 3, 2008

(54) Circuit for charging a capacitor with a power source

(76) Inventor: Christopher T. Schiller, Foresthill, CA (US)

Correspondence Address: LUMEN PATENT FIRM, INC., 2345 YALE STREET, SECOND FLOOR, PALO ALTO, CA, 94306, US

(21) Appl. No.: 11/880,127

(22) Filed: Jul. 19, 2007

Related U.S. Application Data
(60) Provisional application No. 60/832,312, filed on Jul. 20, 2006.

(51) Int. Cl. H02J 15/00

(52) U.S. Cl. 320/166

(57) ABSTRACT

The present invention provides a circuit and method for charging a capacitor with a power source. The circuit includes a capacitor, a power source, and at least two binary-controlled current sources. Each of these current sources is energized by the power source and provides either no current or a predetermined current to the capacitor. Importantly, the two predetermined currents are distinct. The circuit also includes a voltage comparator, which senses changes in the voltage of the power source. In addition, the circuit includes a logic device, which is electrically connected to the current sources and to the voltage comparator. The logic device selects one of the current sources to charge the capacitor based on information obtained by the voltage comparator, i.e. changes in voltage of the power source. Thus, this circuit allows a selectable charging current to be provided to the capacitor based on the voltage of the power source.

### CROSS-REFERENCE TO RELATED APPLICATIONS

This application claims priority from U.S. Provisional Patent Application No. 60/832,312, filed Jul. 20, 2006, which is incorporated herein by reference.

### FIELD OF THE INVENTION

The present invention relates generally to electronics. More particularly, the present invention relates to a circuit and method of charging a capacitor from a power source.

### BACKGROUND

A battery increases its resistance as a function of the discharge (a discharged battery has higher internal resistance than a new one) and temperature (lower temperature increases internal resistance). In a tire pressure monitoring system (TPMS), the entire electronics operates from a single battery, which is expected to provide a 10 year life.

Typically, the transmitter in a TPMS draws about 10 mA during transmission. Typically an open circuit battery voltage is 3 V, and a minimum operation voltage of the electronics is 2V. In such a case, a maximum allowed internal battery resistance would be 100 Ohms (1V/10 mA).

Typically, transmission in a TPMS lasts about 10 milliseconds, once every 100 seconds or so. If a large capacitor (e.g., 100 μF) is connected in parallel to a battery, then this capacitor could be charged (through the internal resistance of the battery) over a long time between transmissions, and discharge during a short transmission, potentially significantly extending the useful battery life and its operational temperature range.

The average TPMS transmission current is reduced by a duty factor, which is a ratio of time between transmissions to the transmission time. In the example above, the duty factor is 10,000:1 (100 s to 10 ms), yielding 1 μA average current needed for transmission.

Large capacitors have a high leakage current, e.g., 100 μA, significantly larger than the average transmission current. As a result, if such a capacitor were permanently connected to a battery, it would significantly reduce the battery life, defeating the objective of reduced power consumption.

A simple solution is to use a switch to connect the capacitor only when it is needed. This approach, however, creates a problem with microcontrollers: when the capacitor is connected to the battery, it momentarily shorts the battery voltage. This voltage drop reboots the microcontroller and thus is not acceptable. Accordingly, there is a need in the art to develop a new solution for charging a capacitor with systems that take advantage of microcontrollers.

### SUMMARY OF THE INVENTION

The present invention accomplishes this goal, while also achieving power savings. In one embodiment, the present invention provides a circuit for charging a capacitor with a power source. The circuit includes several components, in addition to the capacitor and the power source. A first component is at least two binary-controlled current sources. Each of these current sources is energized by the power source. In addition, each current source provides either no current or a predetermined current to the capacitor. Importantly, the two predetermined currents are distinct. A second component is a voltage comparator. The voltage comparator senses changes in the voltage of the power source. A third component is a logic device. The logic device is electrically connected to the current sources and to the voltage comparator. The logic device selects one of the current sources to charge the capacitor based on information obtained by the voltage comparator, i.e. changes in voltage of the power source. Thus, this circuit allows a selectable charging current to be provided to the capacitor based on the state of the power source (for example, the age or temperature of a battery).

In another embodiment, the present invention provides a method of regulating the charging of a capacitor with a power source. According to this method, a capacitor, a power source, and at least two binary-controlled current sources are provided. The current sources are energized by the power source and the current sources energize the capacitor. Each of the current sources provides either no current or a predetermined current to the capacitor. Importantly, these predetermined currents are distinct. The current source with the highest predetermined current is then chosen to initiate charging of the capacitor. All current sources are turned off if the voltage of the power source drops below a defined lowpoint. A current source with a relatively lower predetermined current is chosen if the voltage of the power source rises above a defined highpoint.

### BRIEF DESCRIPTION OF THE FIGURES

The present invention together with its objectives and advantages will be understood by reading the following description in conjunction with the drawings, in which:

FIG. 1 shows a block diagram of a circuit according to the present invention.

FIG. 2 shows an example of the method according to the present invention.

FIG. 3 shows an example of results using the circuit according to the present invention.

### DETAILED DESCRIPTION OF THE INVENTION

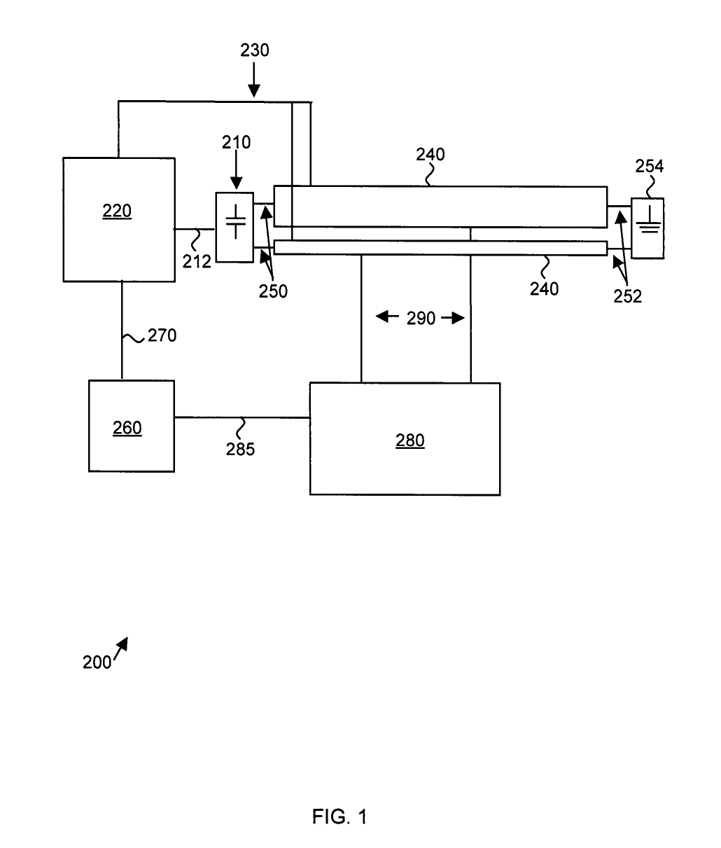

FIG. 1 shows a block diagram of a circuit 200 according to the present invention for charging a capacitor 210 with a power source 220. Power source 220 energizes at least two binary-controlled current sources 240 through connections 230. Each current source 240 provides either no current or a predetermined current to capacitor 210 through connections 250. Capacitor 210 is in turn connected to power source 220 through connection 212. Each current source 240 is also connected through connections 252 to ground 254. The predetermined currents are distinct. Preferably, circuit 200 contains at least 3, more preferably, at least 4, current sources 240. Circuit 200 also includes a voltage comparator 260, which is connected through connection 270 to power source 220. Voltage comparator 260 senses changes in voltage in power source 220. This information (i.e. the sensed changes in voltage) is sent to a logic device 280 through electrical connection 285. Logic device 280 is also connected through electrical connections 290 to current sources 240. Logic device 280 selects one of current sources 240 to charge capacitor 210 based on information obtained by voltage comparator 260. In this way, a selectable charging current is provided to capacitor 210.

In a preferred embodiment, the logic device selects the current source having the highest predetermined current at the initiation of charging. In addition, the logic device turns off all of the current sources if the voltage comparator senses that the voltage of the power source 20 has dropped below a defined lowpoint. Also preferably, the logic device selects the current source having a relatively lower, i.e. intermediate in the case where there are three or more current sources, predetermined current when the voltage comparator senses that the power source has a voltage that has risen above a defined highpoint. In a particularly preferred embodiment, the logic device selects the current source having the lowest predetermined current when the voltage comparator senses that the power source's voltage has dropped below the defined lowpoint a set number of times, e.g. 3.

The circuit according to the present invention may be any type of circuit, including but not limited to an integrated circuit. The power source according to the present invention may be any power source, including but not limited to a battery, or an energy harvester. Similarly, the capacitor may be any kind of capacitor, including but not limited to a capacitor that is part of an integrated circuit, a capacitor that is “off-chip”, or a supercapacitor. The logic device may be any type of logic device, including but not limited to a digital control mechanism, a state machine, or a microprocessor.

The present invention also provides a method of regulating the charging of a capacitor with a power source. According to this method, a capacitor, a power source, and at least two binary-controlled current sources are provided. The current sources are energized by the power source and the current sources energize the capacitor. Each of the current sources provides either no current or a predetermined current to the capacitor. Importantly, these predetermined currents are distinct. The current source with the highest predetermined current is then chosen to initiate charging of the capacitor. All current sources are turned off if the voltage of the power source drops below a defined lowpoint. A current source with a relatively lower predetermined current is chosen if the voltage of the power source rises above a defined highpoint.

In a preferred embodiment, the cycle of turning off the power source if the power source's voltage drops below the lowpoint and choosing a current source with a relatively lower predetermined current if the power source's voltage rises above the highpoint is repeated. More preferably, a current source with the lowest predetermined current is chosen if this cycle repeats more than a set number of times, e.g. 3. In a preferred embodiment, the drops and rises in voltage in the power source is sensed by a voltage comparator and the choosing is implemented in a logic device.

### EXAMPLE

The circuit according to the present invention can be used in many different applications. One particularly desirable application is use in a tire pressure monitoring system (TPMS).

In the present invention, an improved circuit to charge the external capacitor was developed. Instead of a simple circuit, where the capacitor charging occurs through a high value resistor between transmissions, a smart charging circuit, coined the “Stepped Current Switch”, was created, which is driven by a measured battery voltage.

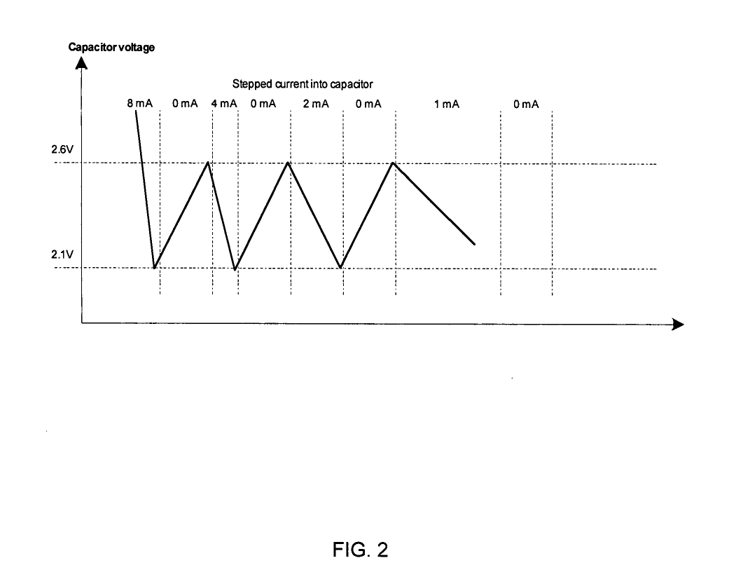

The Stepped Current Switch charges the capacitor using switched current sources. Preferably, at least four binary controlled current sources are used. At the initiation of charging, the highest current (8 mA) is automatically selected. During charging, if the battery voltage drops below a lower setpoint, e.g., 2.1 Volts, charging is halted by turning off all current sources. When the battery voltage recovers to greater than an upper setpoint, e.g., 2.6 Volts, the circuit selects half the initial current (4 mA) and charging continues. If the voltage drops once again below the lower setpoint, the cycle of turn-off, recovery to above the upper setpoint and current halving repeats, as shown in FIG. 2. The change in voltage is sensed by a comparator. If the battery is very old or very cold, then after multiple (e.g., three) occurrences of dropping below the lower setpoint, a minimum current of 1 mA is selected. The cycles of shutdown at 2.1 and turn-on at 2.6 will continue, but the current will continue to be 1 mA. If the battery is new or has low internal resistance, its external voltage may never drop below 2.1 Volts, and the capacitor will be charged at maximum speed using the 8 mA setting. In this way, the charge time of the battery is automatically optimized for the battery condition, resulting in faster charging and reduced energy wasted in capacitor leakage current. The Stepped Current Switch may be enabled by a microprocessor in order to operate, and the microprocessor is free to decide when it is appropriate to enable this function. For example, the microprocessor may measure the battery voltage during or after a data transmission. If the battery voltage does not drop below the critical minimum value, the microprocessor may determine that there is no need to employ the Stepped Current Switch on the subsequent transmission. This choice will save power by avoiding unnecessary capacitor charge/discharge cycles.

The Stepped Current Switch can operate in Normal or Override mode. Once started in Normal mode, the Stepped Current Switch may operate automatically using a hardware state machine. Alternatively, the Stepped Current Switch can operate in override mode, where the microprocessor overrides the hardware state machine, and chooses the values of the stepped current.

The turn-on time for the selected currents should be relatively fast so that if the battery voltage immediately drops below the trip threshold, the circuit will shut down the current before it drops significantly below the lower setpoint.

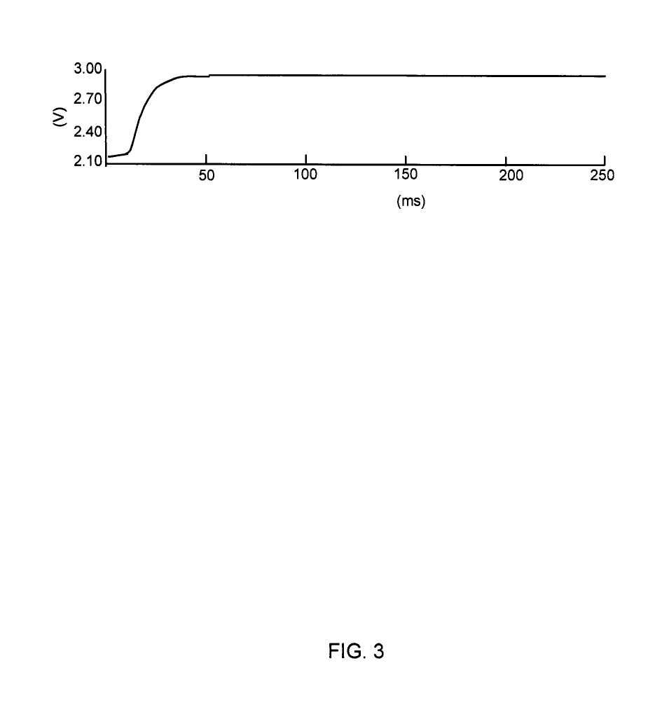

FIG. 3 shows that for 100 ohm battery resistance, the stepped current circuit settles the battery voltage in about 50 ms. In contrast, a traditional resistance switch settles in about 70 ms (not shown). At 2 mA standby current, this saves about 30 μQ per transmission. With an estimated 200,000 transmissions over the operating life of the TPMS, this represents a savings of about 6 mAh.

As one of ordinary skill in the art will appreciate, various changes, substitutions, and alterations could be made or otherwise implemented without departing from the principles of the present invention. Accordingly, the scope of the invention should be determined by the following claims and their legal equivalents.

What is claimed is:

1. A circuit for charging a capacitor with a power source, comprising:
a) a capacitor;
b) a power source;
c) at least two binary-controlled current sources, wherein said at least two binary-controlled current sources are energized by said power source, wherein each of said at least two binary-controlled current sources provides either no current or a predetermined current to said capacitor, and wherein said predetermined currents are distinct;
d) a voltage comparator, wherein said voltage comparator senses changes in voltage of said power source; and
e) a logic device, wherein said logic device is electrically connected to said voltage comparator and to said at least two binary-controlled current sources, and wherein said logic device selects one of said binary current sources to charge said capacitor based on said sensing by said voltage comparator,
whereby a selectable charging current is provided to said capacitor.

2. The circuit as set forth in claim 1, wherein said logic device selects said current source having a highest predetermined current at the initiation of charging said capacitor with said power source.

3. The circuit as set forth in claim 1, wherein said logic device turns off said at least two current sources when said voltage comparator senses that the voltage of said power source has dropped below a defined lowpoint.

4. The circuit as set forth in claim 1, wherein said logic device selects said current source having a relatively lower predetermined current when said voltage comparator senses that the voltage of said power source has risen above a defined highpoint.

5. The circuit as set forth in claim 1, wherein said logic device selects said current source having a lowest predetermined current when said voltage comparator senses that the voltage of said power source has dropped below a defined lowpoint a set number of times.

6. The circuit as set forth in claim 1, comprising at least three binary-controlled current sources.

7. The circuit as set forth in claim 1, wherein said power source is a battery.

8. The circuit as set forth in claim 1 wherein said circuit is an integrated circuit.

9. The circuit as set forth in claim 1, wherein said logic device is a digital control mechanism, a state machine, or a microprocessor.

10. A method of regulating the charging of a capacitor with a power source, comprising:
a) providing a capacitor, a power source, and at least two binary-controlled current sources, wherein said at least two binary-controlled current sources is energized by said power source, wherein said at least two binary-controlled current sources energizes said capacitor, wherein each of said at least two binary-controlled current sources provides either no current or a predetermined current to said capacitor, and wherein said predetermined currents are distinct;
b) choosing the current source with the highest predetermined current to initiate charging of said capacitor by said power source;
c) turning off all current sources if the voltage of said power source drops below a defined lowpoint; and
d) choosing a current source with a relatively lower predetermined current if said voltage of said power source rises above a defined highpoint.

11. The method as set forth in claim 10, further comprising repeating steps c) and d).

12. The method as set forth in claim 11, further comprising choosing a current source with a lowest level predetermined current if said repeating exceeds a set number of repeats.

13. The method as set forth in claim 12, wherein said set number is 3.

14. The method as set forth in claim 10, wherein said dropping and said rising is sensed by a voltage comparator.

15. The method as set forth in claim 10, wherein said choosing is implemented in a logic device.
